(19) United States
(12) Patent Application Publication
(10) Pub. No.: US 2022/0023131 A1
(43) Pub. Date: Jan. 27, 2022

(54) WEARABLE ACTIVE ROBOT FOR BODY JOINTS IN SERIES

(71) Applicant: SCUOLA SUPERIORE DI STUDI UNIVERSITARI E DI PERFEZIONAMENTO SANT'ANNA, Pisa (PI) (IT)

(72) Inventors: Andrea BALDONI, Perugia (PG) (IT); Simona CREA, Lucca (LU) (IT); Nicola VITIELLO, Pontedera (PI) (IT)

(73) Assignee: SCUOLA SUPERIORE DI STUDI UNIVERSITARI E DI PERFEZIONAMENTO SANT'ANNA, Pisa (PI) (IT)

(21) Appl. No.: 17/281,855

(22) PCT Filed: Oct. 4, 2019
(86) PCT No.: PCT/IB2019/058469

§ 371 Date: Mar. 31, 2021

(51) Int. Cl. A61H 1/02; A61H 3/00

(52) U.S. Cl. CPC A61H 1/024; A61H 1/0244; A61H 3/00; A61H 2003/007; A61H 2201/5064; A61H 2201/1238; A61H 2201/1436; A61H 2201/1223; A61H 2201/1642; A61H 2201/165

(57) ABSTRACT

The present concerns a wearable underactuated active robot with a couple of robotic joint adapted to correspond with to a couple of body joints in line on a limb of an user.

### SUMMARY OF THE INVENTION

The present invention is in connection with an underactuated wearable active robot with a single actuation comprising two motion outputs adapted to be associated to a couple of body joints in series or in line on a limb of an user. Not limiting example of couple of body joints in series are knee-ankle, shoulder-elbow, elbow-wrist, hip-knee.

### BACKGROUND OF THE INVENTION

The term active wearable robot in the present description is used to generically indicate any mechanically implemented prosthetic or exoskeletal device intended to be worn by a user to aid motion or to replace a limb and/or body portion.

As is known, the constructive complexity of such robots tends to make them bulky and heavy; therefore, difficulties arise with the known robots in practical use, especially for certain subjects (for example elderly or frail individuals), who may even be unable to wear the robot. In any case, this kind of robot tends to be uncomfortable or heavy to wear for all other subjects.

The technology is therefore shifting with a view to seeking to reduce the size and weight of wearable robots. The reduction of weight and dimensions in exoskeletal robots would not only allow more user-friendly use but also greater tolerability of the robot itself. In fact, very heavy or even simply bulky robots are poorly accepted by the user, either because of the difficulty of use, or because of the strong aesthetic and emotional impact they cause in use.

An example of a technical solution used to make an underactuated robot is described in U.S. 2016310344: this system describes a pelvis orthosis with a single actuator associated with a differential which distributes the motion output from the actuator to two differential motion outputs, respectively associated with corresponding prosthetic joints each with a hip joint. This system is therefore applied to two articulations operating against each other in phase opposition. Going further into detail and considering the phases of walking, when a hip joint performs the swing movement forward of the leg, the opposite hip joint performs the opposite movement, i.e. it is in counter-phase. The application of a differential system to this articulation torque is indicated by the fact that by its nature the differential provides the motion in algebraically differential amounts to the two motion outputs, both in the active state.

### SUMMARY OF THE INVENTION

The object of the present invention is to provide an underactuated wearable robot with differential motion distribution also for pairs of articulations in line on the same limb.

The object of the present invention is also to provide an actuation system which reduces the energy used.

These and other objects are achieved by an active wearable robot according to the first of the appended claims. Further features of the invention are the subject matter of the dependent claims.

The characteristics and advantages of the system according to the present invention will appear more clearly from the following description of an embodiment thereof, provided by way of non-limiting example with reference to the appended drawings wherein:

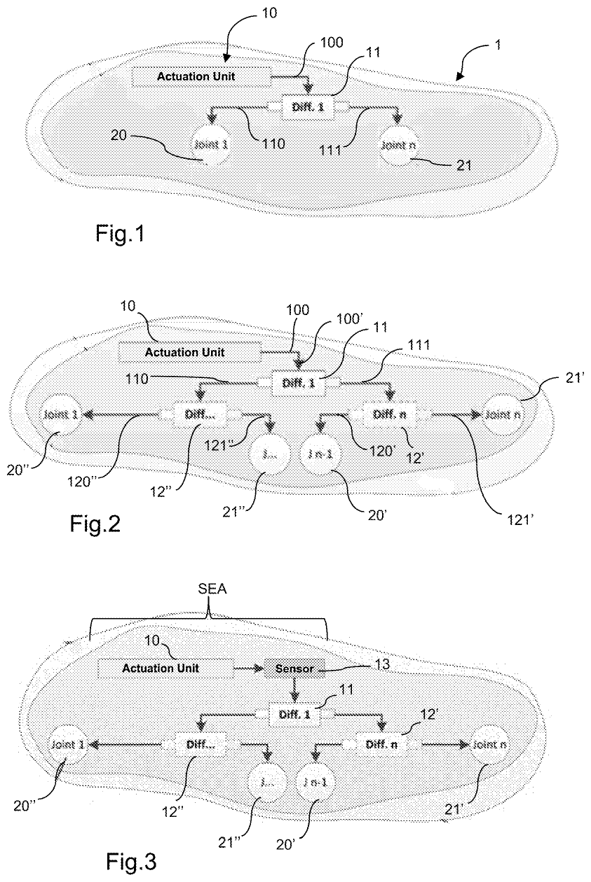

FIG. 1 schematically shows a block representation of a underactuaction group for a wearable robot;

FIG. 2 is again a representation of a wearable robot with the underactuaction group of FIG. 1;

FIG. 3 schematically shows a representation of a specific embodiment of a underactuation group for the robot, including torque sensing means;

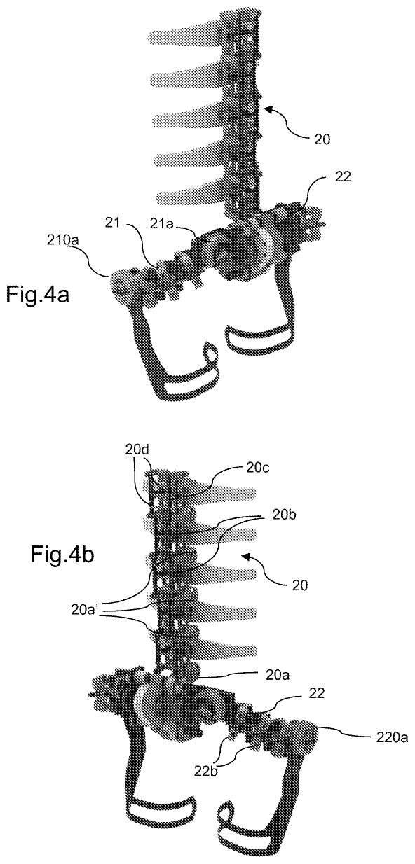

FIGS. 4a and 4b show from two different prospectives a first embodiment of a wearable robot with an under-actuation unit connected to three articulable modules which specifically are two hip modules and a back module;

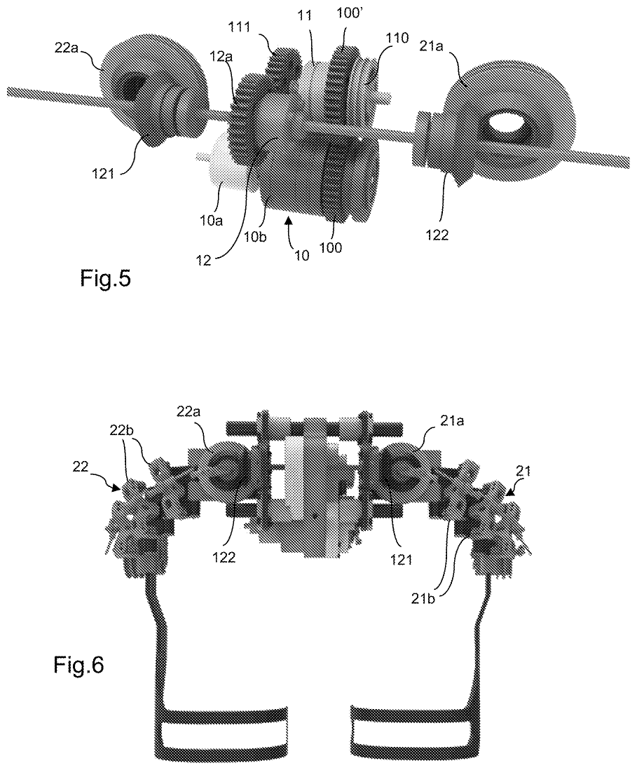

FIG. 5 shows a detail of the underactuation group of the robot of FIGS. 4a and 4b;

FIG. 6 shows an embodiment of a wearable robot with an under-actuation unit connected to two articulable exoskeletal modules, which specifically are two hip modules;

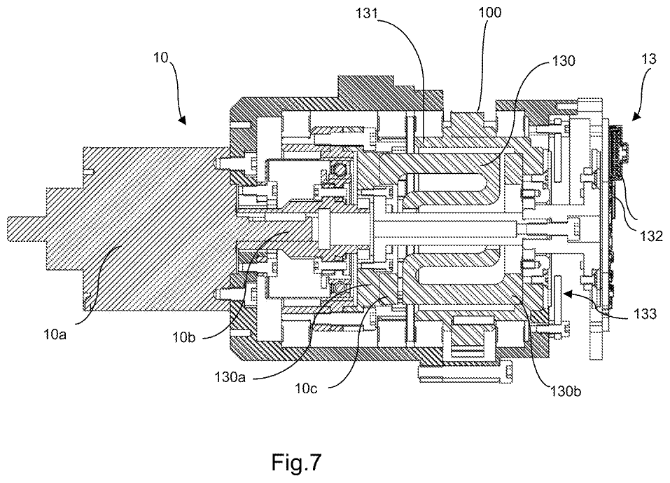

FIG. 7 shows an example of an SEA type architecture;

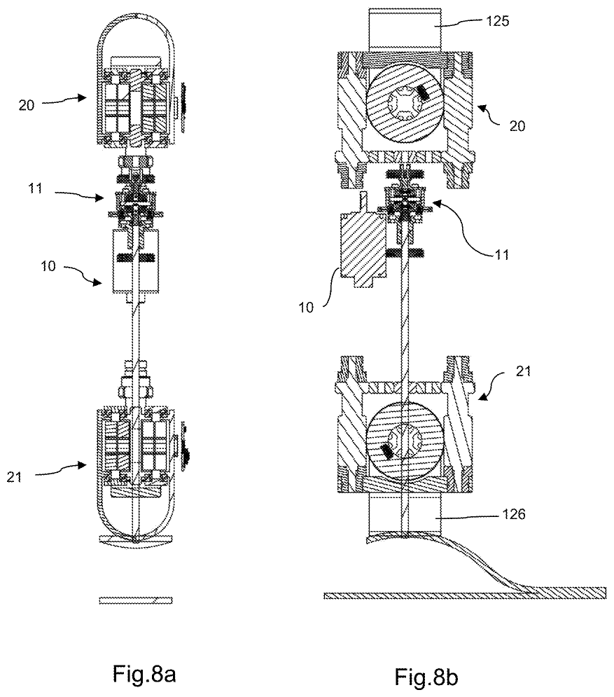

FIGS. 8a and 8b schematically show an embodiment of a wearable robot with an underactuation group connected to two articulable exoskeletal modules, which are specifically a knee module and an ankle module;

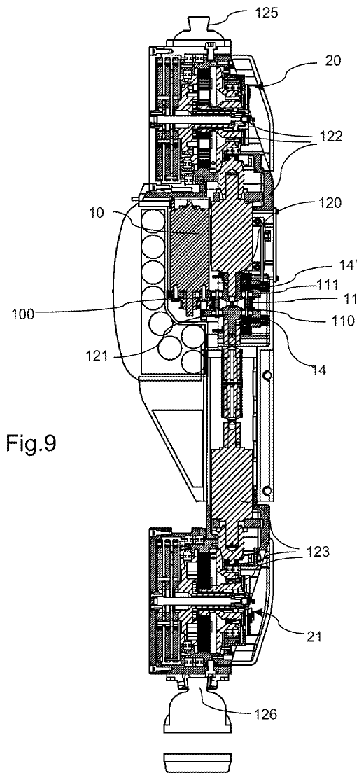

FIG. 9 is a longitudinal section view of an embodiment of the articulable robot with an under-actuation group connected to a knee module and an ankle module;

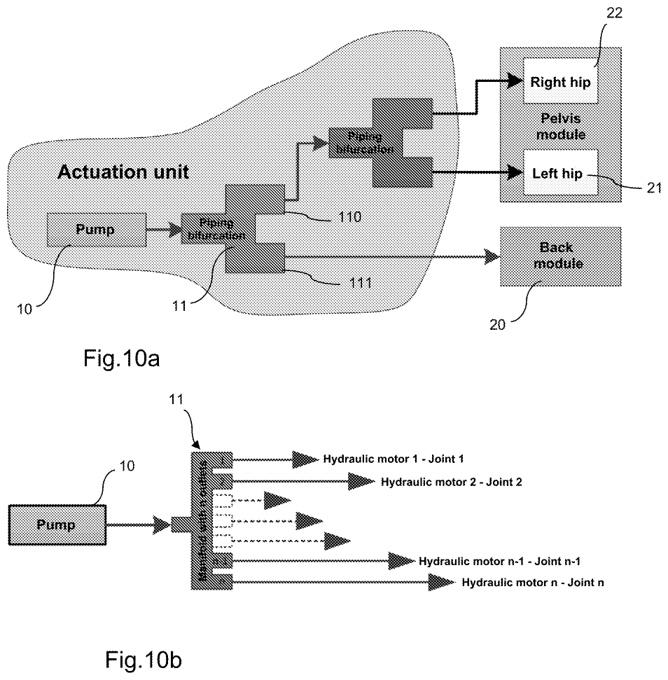

FIGS. 10a and 10b schematically illustrate two possible embodiments of the underactuation group of the preceding figures.

### DETAILED DESCRIPTION OF THE INVENTION

With reference to the above mentioned figures and in particular for the time being to FIGS. 1 and 2, a underactuaction group is described generally indicated with the reference number 1, adapted to be installed on an active wearable robot, globally indicated with the reference number 2.

The term active wearable robot is generally indicated as any prosthetic or exoskeletal device mechanically actuated and intended to be worn by a user in aid of or in replacement of a limb and/or body portion.

The underactuation unit 1 comprises actuation means 10 adapted to generate a torque at a single primary motion output 100 thereof. In the example of use relating to active wearable robots the primary motion output is associated with at least two articulable exoskeletal modules 20, 21 of the robot destined to correspond, in use, with respective mono- or poly-articular body joints of the user.

The actuation means comprises one or more actuators commanded by an energy source controlled by an electronic controller (not shown). The term actuator can be understood as linear actuators but also, for example and not limited to, electric motors, electro-active polymers, hydraulic power systems such as a hydraulic pump.

The term articulable exoskeletal module means any joint actuatable by the robot that has at least one degree of freedom, such as for example knee, ankle, elbow, wrist joints. However, poly-articulated structures comprising kinematic chains are also comprised in this definition; structures of this kind are adapted to be particularly associated with the back and markedly with the spinal articulation of the user and in this case follow and reproduce the movements of the user's spine or pelvis and in this case reproduce the movement of the pelvis-hip joint. An example of a poly-articulated structure adapted to the application in association with the pelvis-hip joint is described in patent application WO2017216663 by the same applicant.

An example of a poly-articulated structure specifically adapted to the association with the user's spine will instead be made later in the continuation of the description.

As mentioned above, the actuation means 10 defines the motion output 100 to which a first motion distribution element 11 is connected. The first motion distribution element 11 therefore receives in input 100′ the torque generated in output by the actuation means 10.

The first motion distribution element 11 also defines two differential derivative motion outputs 110 and 111. For example each differential motion output is adapted to connect with a respective articulable module 20, 21 of the robot or with a second motion distribution element 12, 12′ in turn operatively interfaced with at least two further articulable exoskeletal modules 20′, 21′, 20″, 21″.

Therefore, the actuation means 10, although defining a single primary motion output 100, obtains themselves the movement of at least two articulable modules 20, 21, thanks to the interposition of the first motion distribution element 11 which receives the motion input from the actuation means and distributes it in differential mode (as a differential gearing) to the two derivative outputs 110, 111 and therefore, consequently, to the articulable exoskeletal modules operatively connected thereto.

The articulable exoskeletal modules that can be actuated with the actuation means 10 are therefore potentially infinite. For example, reference should be made to the schematisation of robots of FIG. 2 where a further motion distribution element and specifically a second 121 and third motion distribution element 12″ are connected to each derivative motion output 110, 111 of the first motion distribution element 11. Second and third groups of actuatable modules of the robot 20′, 21′, 20″, 21″ are in turn connected to the differential motion outputs 120′, 121′, 120″, 121″ of each of said second and third distribution elements. Therefore, in this case four articulable exoskeletal modules are implemented with the actuation means 10. If on the other hand the second 12′ and third motion distribution element 12″ in turn had fourth and fifth motion distribution elements connected, the potentially feasible exoskeletal modules starting from the single primary output 100 defined by the actuation means 10 would be in even greater numbers. The underactuation unit thus obtains the movement of complex robotic structures with a constructive simplicity that has never been reached by the currently known robots.

The torque transmission unit further comprises torque sensor means.

These sensor means can comprise, for example but not limited to, a transmissive element with elastic response for the transmission of a torsional stress associated with at least one position encoder to determine its torsional bending and therefore the torque, knowing the elastic constant of the elastic transmission element.

FIG. 7 shows an embodiment example of SEA architecture (series elastic actuator), comprising sensor means in series with actuation means.

In the embodiment described, the sensor means 13 is interposed between the first motion distribution element 11 and the actuation means 10, therefore corresponding to the primary motion output 100.

The torsional elastic transmissive element is indicated in the figure with the number 130. The actuation means in turn comprises a motor 10a and a crankshaft 10b which defines a reduced motion output 10c. This reduced motion output of the crankshaft 10b is interfaced to a first connection flange of the transmissive element 130a; a second flange 130b longitudinally opposite to the first is connected to a cup-like connection element 131 which supports on its outer periphery the primary motion output 100 of the actuation means 10. Further, the sensor means comprises two encoders in this specific embodiment, of which a first encoder 132 is mounted so as to read the movement on the first flange 130a and a second encoder 133 is mounted so as to read the movement on the second flange 130b. The difference in measurement read between the two encoders allows evaluating the torsional flexion of the elastic transmission element and therefore, knowing the elastic constant, the torque transmitted to the cup-like connection element and therefore on the primary motion output 100. Possibly only one encoder can be provided, for a direct reading of the torsional flexion.

The sensor means 13 is therefore adapted to detect the torque actually absorbed by the first motion distribution element.

This actually absorbed torque also includes any external perturbation that is exerted in feedback on the actuation means from the derived motion outputs. For example, this external perturbation is a feedback action exercised by a user wearing a robot on which the transmission unit is installed. In fact, if the user has residual mobility, he or she can move the joint and consequently the module at the associated joint. This movement enters as a force exerted from the outside in the differential, algebraically adding the input power to the differential given by the single primary motion output. The sensor 13 therefore detects a deviation between the power actually managed by the differential and that supplied by the actuator. This deviation, except for the deviation due to the internal frictions of the mechanisms and to possible errors, is therefore a function of the external perturbation mentioned above.

The sensor means is typically interfaced with a control unit configured for feedback control of the actuation means as a function of this deviation and consequently also as a function of the external perturbation received from at least one of the two derivative outputs.

In the case of application to the robot, this feedback control allows making the robot “transparent” in relation to any force exerted by the user directly on the articulable module, a force which, in the absence of such control, would be undesirably and in a substantially uncontrolled way redistributed by the motion distribution element, based on the differential distribution criterion, to one or more articulable exoskeletal modules connected thereto.

Specifically, the SEA architecture is able, by reading the deformation of the torsional elastic transmissive element located downstream of the actuation means and upstream of the motion distribution element, to give the control unit the information, of which the torque passes in that transmission section and therefore allows closing the control loop in a timely manner as regards the active provision for the necessary motor task. This architecture also allows the robot to be controlled in feedback if the user wishes to be able to impose motion from the outside. If an irreversible transmission was to occur, all the movement imposed by a derivative output of the motion distribution element would have the same and opposite repercussion on the second, which clearly could not move freely. Sensor means upstream of the motion distribution element therefore allows the motor to cancel the resisting torque by going to cancel the algebraic difference of the motion generated by the two derivative outputs subjected to an input force supplied from the outside, i.e. by the user himself.

In a preferred embodiment, the motion distribution element is a differential. The differential is mechanical, i.e. materialised by an epicycloidal gearing.

The differential may possibly also be of the pneumatic/hydraulic type as shown in FIGS. 10a and 10b. In greater detail in this case the actuation means 10 comprise a hydraulic pump and the motion distribution element is materialized by a pipe whose fluid inlet 100′ materializes the motion input, while the derived outlets 110 and 111 represent motorcycle exits. Each output of motion is connected at the input to a hydraulic motor which actuates a relative joint.

Reference will now be made to the embodiments illustrated in FIGS. 4a, 4b, 5. In these examples actuation means 10 comprising an electrical motor 10a in series with a sensorized spring at the ends 10b, to define an architecture of the SEA type such as the one previously described. The primary motion output 100 is materialised by a first meshing member. This primary motion output 100 is connected to a first differential 11 which has a second meshing member 110′ adapted to mesh with the first meshing member 100 to receive the torque delivered by said actuation means 10. Specifically, the first and second meshing members are materialised by toothed wheels, even if other equivalent functional solutions can be provided.

The first differential 11 provides two derivative/differential motion outputs, of which a first derivative output 110 and a second derivative output 111. The first derivative output 110 is connected to a first articulable module 20. The second derivative output 111 is connected to a second differential 12.

The first derivative output 110 is materialised by a meshing member such as a pulley adapted to operatively interface with a respective motion input pulley 20a to the first articulable module 20, as shown specifically in FIG. 4b. In the specific case, the pulley 20a supplies the input motion to an articulated kinematic mechanism adapted to be associated with the spinal joint, i.e. to the spine of a user.

In this specific example, the articulated kinematic mechanism comprises an exoskeletal kinematic chain adapted to assist the movement of a poly-articular bone chain, comprising a number of bone links and a number of anatomical rotoidal joints each of which is such as to allow a relative rotation between two bone links adjacent thereto. The exoskeletal kinematic chain comprises respective exoskeletal links 20b and exoskeletal rotoidal joints 20d; each exoskeletal rotoidal joint allows a relative rotation between two exoskeletal links adjacent thereto. At each exoskeletal rotoidal joint a pulley 20a′ is arranged which is adapted to rotate about a corresponding pivot axis, and at least one inextensible cable 20c in contact by friction with each pulley 20a′. The relative derivative motion output is adapted to drive the cable 20c so as to bring the exoskeletal links to rotate around the respective exoskeletal rotoidal joints. Possibly two or more cables can be provided which are alternately driven so as to bring the exoskeletal links to rotate clockwise and/or counter-clockwise around respective exoskeletal rotoidal joints.

The second derivative output 111 is materialised by a meshing member (specifically a geared wheel, even if also in this case the implementation of other functionally equivalent solutions cannot be excluded).

This second derivative output 111 is connected with the motion input 12a of the second differential 12, materialised by a complementary meshing member. The second differential further provides a first 121 and a second motion output 122. These two further derivative motion outputs 121 and 122 are meshed on respective motion inputs 21a and 22a of two second 21 and third articulable exoskeletal modules 22 to provide rotational movement. In particular, the two motion inputs 21a, 22a are materialised by pulleys which have a degree of freedom in rotation according to an axis thereof that is perpendicular to the axis of the second differential motion output. These pulleys supply the motion to an articulated kinematic motion which defines the two second and third articulable modules 21 and 22 which in the specific case are adapted to be associated with the articulation of the user's pelvis-hip. These articulable modules 21 and 22 are for example of the type described in the previous patent application of the same holder mentioned above, i.e. WO2017216663. In greater detail, the articulable exoskeletal modules 21 and 22 are each materialised by a kinematic chain that allows the transmission of rotary motion between an active rotating element materialised by each of the motion input pulleys 21a and 22a and a distal rotating member. The two rotating members have axes that can assume any relative orientation. The distal rotating member is also materialised by a respective pulley, shown in the figures and indicated with the references 210a and 222a. The first rotating member is therefore adapted to rotate about its own pivot axis X. The second rotating member is in turn adapted to rotate about its own pivot axis Y.

The kinematic chain also comprises a plurality of connection elements 21b, 22b each of which comprises at least one passage having at least one rotating element; each connection element further comprises at least one interface adapted to connect the connection element to an adjacent one and to one of the rotating elements, generating a rotational constraint around a pivot axis Z thereof.

The chain then comprises a transmission element (not visible), such as a cable or a belt, adapted to extend along a determined path to transmit a rotary motion between the two rotation elements.

Therefore, the kinematic chain is adapted to pass between an adjustment configuration in which each connection element is adapted to rotate about its own pivot axis Z to adjust its angular position with respect to an adjacent connection element or to one of the rotation elements, and a transmission configuration in which when the first rotation element rotates about its own pivot axis X, the distal rotation element performs a proportional rotation about its own axis Y; in the transmission configuration each connection element is adapted to not rotate about its own pivot axis Z.

FIG. 6 shows a further embodiment which is a simplified version of the one just described, in which the second differential 12 is not present and the two derivative outputs of the first differential 121, 122 are connected to as many articulable exoskeletal modules 21, 22, materialised in this case by articulated kinematic mechanisms of the pelvis-hip such as those described above.

Now consider FIGS. 8a and 8b and 9. In this solution, which illustrates an exoskeletal robot and specifically a prosthesis, a underactuaction group 1 is connected with two articulable exoskeletal modules which are respectively a knee joint 20 and a joint of ankle 21.

In the knee-ankle prosthesis solution described above it is worth noting that the joints are serial to one another, i.e. the two joints act in motion one in continuity with the other, in the various phases of walking.

Now consider FIGS. 8a, 8b and 9. In these figures a prosthesis or active wearable knee-ankle robot is represented; in general the solution that will now be described applies to any active wearable robot solution for a limb with a pair of consequential exoskeletal joints, i.e. arranged in sequence on the same limb. Examples of pairs of consequential joints are: shoulder-elbow, knee-ankle, elbow-wrist, hip-knee, etc.

The pair of joints defines a distal joint and a proximal joint, as a function of their distance from the trunk. For example, in the case of the knee-ankle pair, the knee joint is proximal, while the ankle joint is distal. The joints of these pairs work in series during movement; if we consider the movement of a step in the case of the specific knee-ankle example, the movement of the ankle is sequential to that of the knee.

The robot of these figures comprises at least:

actuation means 10 defining a single primary motion output 100;

a motion distribution member 11 connected to said primary motion output 100 to receive the motion generated by said actuation means 10 in input and to distribute it in differential mode through two derivative motion outputs 110, 111;

two articulable exoskeletal modules 20, 21, each associated with a derivative motion output, and arranged in line adapted to each correspond to a respective body joint of said user of said pair of consecutive joints.

The motion distribution member is a differential gearing as described above.

Contrary to the previous embodiments, associated with non-consecutive body joints (for example pelvis or pelvis and back solutions, described above), in the case of application to a pair of consecutive joints (such as for example knee-ankle, elbow-wrist, shoulder-elbow, hip-knee) the differential is used as a mechanical node for internal power recovery. This function is possible due to the fact that the joints operate serially to each other during the phases of motion and therefore the two motion outputs do not necessarily have to simultaneously supply the modules. For example, refer to a step in the case of the knee-ankle pair. During the swing phase of the leg the knee joint accumulates kinetic energy. This kinetic energy enters as a torque value in the differential distribution system, representing an external perturbation, i.e. a torque not supplied by the actuation and by the single primary motion output. This energy is scaled from that required for actuation 10, thus reducing the overall consumption of power. Moreover, this energy can be redistributed, controlling the two derivative motion outputs, to the second differential motion output, that associated with the ankle module. In this type of joint pair, the differential therefore functions as an internal power recirculation group.

The robot can further comprise braking means 14, 14′. In a preferred embodiment, the braking means comprises disc brakes.

The brakes are used to direct and distribute the torque delivered between the differential motion outputs. In fact, by braking one of the two outputs, the torque delivered by the other motion output is greater. This behaviour can also be used to redistribute the external energy supplied in input as a perturbation by braking one of the two joints and forcing the power to exit in a differential manner from the non-braked or less-braked joint.

The braking means therefore has the purpose of modulating the power flow between one or the other output of the unit itself as a function of the movement that the user must perform.

The braking means also allows making the joint irreversible, i.e. in the event of a sudden stop, it blocks the joint, making the structure rigid and allowing the user to place his weight on it.

In general, although it has been specifically described for this embodiment, nothing prevents the braking means from also being applied to the previously described embodiments.

The robot for pairs of consequential body joints can also comprise:

position detecting means located downstream of the actuation and motion distribution element and adapted to detect, based on a torque and/or position value, the actual position of the exoskeletal module;

a control unit that controls in feedback, based on the comparison between the actual position value of the exoskeletal joint with a desired position value, the torque value supplied in input to each of said exoskeletal modules articulable by each respective derivative motion output.

Going further into detail, the control unit, when faced with a difference detected between the actual position value of a joint, for example the ankle joint, and the desired value, adjusts the delivery of torque from each of the two derivative motion outputs. If the robot has braking means installed, the control unit carries out this adjustment by operating on the braking means itself. In this way the power supplied by the motor is divided in favour of the non-braked or in any case less-braked derivative motion output. Taking again a step as an example, if the position value of the ankle module does not correspond to the desired one, the control unit acts by braking the derivative motion output associated with the knee module, so that the torque delivered by the derivative motion output associated with the ankle module is greater and can recover the difference in the detected position value.

The position detecting means is located downstream of the differential motion distribution unit.

In one possible embodiment, the position detecting means comprises, for example, position and/or torque sensors.

In a preferred embodiment the detection means comprises a transmissive element with elastic torsional response and at least one position encoder to determine the torsional flexion of this transmissive element. Detection means of this type is substantially similar to that described with reference to FIG. 6 and associated with the motor 10 in the SEA-type architecture. This solution therefore not only detects the torque but also the position of the module. The solution has a further advantage: the interposition of an elastic element between the motion output and the module gives the robot an elastic interaction with the user and in general with the outside that make its behaviour similar to that of user.

The detection means can also possibly only comprise a torque sensor allocated on one of the two modules. The module position can be derived derivatively starting from the torque detection.

The detection means can be provided on each module, or it can be one in number. In this case the position information on the other module will be derived from the information obtained by direct detection on the module with the sensor.

FIGS. 8a and 8b also show universal joints of the known type 125, 126 for the connection of the prosthesis to an orthotic shell and/or to a prosthetic foot.

In the embodiment illustrated in FIG. 9, suitable reductions are interposed between each motion output and the respective module, indicated in the figure with the reference number 122, 123.

Additionally, further sensor means can be provided between the actuation means and the motion distribution element (as in the SEA architecture described above) to have a further control stage, not only on the derivative motion outputs but also on the power delivered directly at the input to the distribution element from the single motion output 100.

Although the embodiment described in figures from 8a to 9 refers to a wearable knee-ankle robot, nothing prevents the same architecture from being applied to a wearable robot that can be associated with any pair of consequential body joints, such as for example the shoulder-elbow pair, elbow-wrist, hip-knee, etc.

The present invention has been described with reference to a preferred embodiment thereof. It is to be understood that there may be other embodiments that relate to the same inventive nucleus, all falling within the scope of protection of the claims provided below.

1. An active robot wearable by a user comprising:
actuation means defining a single primary motion output;
a motion distribution element connected to said primary motion output to receive the motion generated by said actuation means in input and to distribute it in differential mode through two derivative motion outputs;
two exoskeletal modules each connected to one of said two derivative motion outputs, arranged in line and adapted to each correspond to a body joint of said user where said body joint belongs to a pair of joints consecutively arranged on a limb.

2. The robot according to claim 1, further comprising braking means operatively associated with each of said derivative motion outputs, wherein said braking means acts on said derivative motion outputs to adjust the output power provided by each of them to the respective module.

3. The robot according to claim 2, further comprising:
position detection means located downstream of said actuation means and of said motion distribution element and adapted to detect the position and/or actual torque associated with each of said modules;
a control unit for controlling in feedback, based on the comparison between the position and/or actual torque value of said exoskeletal module with a desired position and/or torque value, the power value supplied in input to each of said articulable exoskeletal modules by each respective derivative motion output.

4. The robot according to claim 3, wherein if said position and/or actual torque value of a first of the two modules does not correspond to said desired value, said control unit activates the braking means associated with the derivative motion output connected to a second of the two modules, so as to increase the power delivered by the non-braked derivative motion output.

5. The robot according to claim 4, wherein the braking means comprises disc brakes.

6. The robot according to claim 1, wherein said detection means comprises sensors located on at least one of said modules, adapted to detect the input torque to said module.

7. The robot according to claim 1, wherein said detection means comprises sensors adapted to detect the position of at least one of said modules.

8. The robot according to claim 1, wherein said detection means comprises torque and position sensors, located on at least one of said modules.

9. The robot according to claim 8, wherein said sensors comprise a transmissive element with torsional elastic response and at least one position encoder to determine the deflection of said transmissive element.

10. The robot according to claim 1, wherein said pair of body joints arranged consecutively is formed by a knee joint and an ankle joint.

11. The robot according to claim 1, wherein said motion distribution element is a differential epicycloidal gearing.

12. A leg prosthesis wearable by a user comprising:
actuation means defining a single primary motion output;
a motion distribution element connected to said primary motion output to receive the motion generated by said actuation means in input and to distribute it in differential mode through two derivative motion outputs;
two exoskeletal modules each connected to one of said two derivative motion outputs, arranged in line and respectively corresponding to a knee joint and an ankle joint of said user,
braking means operatively associated with each of said derivative motion outputs, wherein said braking means acts on said derivative motion outputs to adjust the output power provided by each of them to the respective module;
position detection means located downstream of said actuation means and of said motion distribution element and adapted to detect the position and/or actual torque associated with each of said modules.

13. The leg prosthesis wearable by a user according to claim 1, which further comprises a control unit for feedback control, based on the comparison between the position and/or actual torque value of said exoskeletal module with a desired position and/or torque value, the value of power supplied in input to each of said articulable exoskeletal modules by each respective derivative motion output; whereby if said position and/or actual torque value of a first of the two modules does not correspond to said desired value, said control unit activates the braking means associated with the derivative motion output connected to a second of the two modules, so as to increase the power delivered by the non-braked derivative motion output.
